(19) United States
(12) Patent Application Publication
(10) Pub. No.: US 2008/0077293 A1
(43) Pub. Date: Mar. 27, 2008

(54) SYSTEM AND METHOD FOR EXTENDING THE RANGE OF RUN-FLAT TIRES

(75) Inventor: Patrick J. Fitzgibbons, Owego, NY (US)

Correspondence Address: BURNS & LEVINSON, LLP, 125 SUMMER STREET, BOSTON, MA, 02110, US

(73) Assignee: LOCKHEED MARTIN CORPORATION, Bethesda, MD (US)

(21) Appl. No.: 11/850,385

(22) Filed: Sep. 5, 2007

Related U.S. Application Data
(63) Continuation-in-part of application No. 11/430,771, filed on May 9, 2006, now abandoned.

(51) Int. Cl. B60G 23/00

(52) U.S. Cl. 701/37; 280/5.514

(57) ABSTRACT

A method and system for extending the range of run-flat tires by providing ride height control. When the vehicle has a damaged tire or tires the ride height of an appropriate suspension system(s) is capable of being adjusted to achieve a level attitude for the vehicle thus preventing destructive loads from being placed on the damaged run-flat tire(s).

### CROSS REFERENCE TO RELATED APPLICATIONS

This application is a continuation-in-part of U.S. application Ser. No. 11/430,771, filed May 9, 2006 and incorporated herein by reference in its entirety.

### STATEMENT REGARDING FEDERALLY SPONSORED RESEARCH OF DEVELOPMENT

This invention was made and funded by the U.S. Government, specifically by the U.S. Army Tank-Automotive & Armaments Co. under Contract W56HZV-05-9-0002. The U.S. Government has certain rights in the invention.

### FIELD OF THE INVENTION

The present invention relates generally to the field of vehicles, and, more particularly, to extending the range of run-flat tires.

### BACKGROUND OF THE INVENTION

The majority of vehicles, including some tactical military vehicles, travel on inflatable tires that are vulnerable to damage. Damage may arise from a number of sources in a military environment, including munitions projectiles such as enemy fire, rocks, pot holes, and sharp objects lying in the road. Commonly, the result of an encounter of a tire with such an object is a deflated tire.

The response to a deflated tire may include two options. The tire may be replaced at the site where the damage occurred. However, safety issues may preclude replacement at the site. A military vehicle operating under enemy fire lacks an option of stopping to replace a damaged tire and must continue its movement to leave the hostile area.

A second option is continuation of travel, albeit at a reduced speed, to a location having conditions more suitable for replacing the damaged tire. Making this possible are conventional run-flat tires, which are capable of running flat when deflated. Generally, run-flat tires have a run-flat insert that allows rotation of the wheel on which the run-flat tire is mounted while support for the vehicle continues.

However, run-flat tires by themselves are just a stop gap measure. In addition to imposing a limitation on the speed of the vehicle, run-flat tires have a limited range. Since the radius of a deflated run-flat tire is considerably less than the radii of the remaining inflated and undamaged tires, the vehicle tilts toward the deflated run-flat tire and, as a result, shifts part of the load previously carried by the inflated tires onto the now deflated run-flat tire. Even if such load shifting and side loading are design considerations for the tire, such forces may still restrict the operating range of a deflated run-flat tire.

Thus, in vehicles utilizing run flat inserts in their tires, the range such a vehicle can travel with a flat tire is limited due to the eventual total destruction of the tire. This destruction is accelerated by the fact that once a tire has been flattened the vehicle assumes a tilted attitude toward that flat and thus shifting additional weight and side loads onto the already damaged tire.

For the above reasons, it would be beneficial to provide a method and system to extend the range of a vehicle operating on run-flat tires before destruction of the tire or insert occurs rendering the vehicle immobile.

### SUMMARY OF THE INVENTION

The needs of the invention set forth above as well as further and other needs and advantages of the present invention are achieved by the embodiments of the invention described herein below.

The present invention provides a method to control the vehicle's attitude to prevent additional weight and side loads from being placed on the damaged tire and thus increase the range that the vehicle can travel.

Such a remedy is provided by individual wheel station ride height control. This is possible on vehicles such as the LM FTTS due to its 4-corner independent suspension and adjustable ride height capabilities. When the vehicle has a damaged tire or tires the operator would adjust the ride height of the appropriate wheel stations appropriately to achieve a level attitude for the vehicle thus preventing additional destructive loads from being placed on the damaged tire(s). This process may be automated so that one push of a button would adjust each wheel station appropriately.

In one embodiment, a method for extending the operating range of a deflated run-flat tire on a vehicle, comprises the steps of determining that a tire on the vehicle is deflated, and adjusting one or more of a plurality of adjustable supports. One example, although not limited thereto, is utilizing existing suspension height adjustment to compensate for tilting of the vehicle due to the deflated tire. Such adjustment may be only necessary in one corner (suspension) of the vehicle.

The step of adjusting may include adjusting one or more of the plurality of adjustable supports by a distance substantially equal to a difference in radius between an inflated run-flat tire and a deflated run-flat tire.

The vehicle may include a pair of parallel wheels with separate run-flat tires having separate wheels located opposite each other on opposite sides of the vehicle and mounted on respective suspension components attached to a chassis of the vehicle, wherein the plurality of adjustable supports may include a separate adjustable support located to determine a suspension height adjustment between each respective wheel and the chassis, and further wherein the step of adjusting may include adjusting either one or both of the plurality of adjustable supports to compensate for tilting of the vehicle caused by a single deflated tire. The step of adjusting may include shortening an adjustable support corresponding to a tire that is still inflated to compensate for tilting of the vehicle caused by a deflated tire. The step of determining that a tire is deflated may include monitoring air pressure in one or more tires of the vehicle. The step of adjusting may include monitoring vehicle tilt.

In another embodiment, a system for extending the operating range of a deflated run-flat tire on a vehicle, comprises means for detecting an existing suspension height adjustment of the vehicle, and means for adjusting one or more of a plurality of adjustable supports on the basis of a detected existing suspension height adjustment to compensate for tilting of the vehicle due to the deflated tire.

The means for adjusting may be adapted to adjust one or more of the plurality of adjustable supports by a distance substantially equal to a difference in rolling radius between an inflated run-flat tire and a deflated run-flat tire.

The vehicle may include a pair of parallel wheels having separate wheels located opposite each other on opposite sides of the vehicle and mounted on respective suspension components attached to a vehicle chassis, wherein the plurality of adjustable supports may include a separate adjustable support located to determine a suspension height adjustment between each respective wheel and the chassis.

The vehicle may include a second pair of parallel wheels having separate wheels located opposite each other on opposite sides of the vehicle and mounted on respective suspension components attached to the chassis, said second pair of parallel wheels being longitudinally separated along the vehicle chassis from the first recited pair of parallel wheels, wherein the plurality of adjustable supports may include a separate adjustable support located to determine a suspension height adjustment between the chassis and each respective wheel of the second pair of parallel wheels. The means for adjusting may be adapted to compensate for tilting in a longitudinal direction of the vehicle.

The system may further comprise means for detecting a deflated run-flat. The means for detecting a deflated tire may include a pressure sensor associated with one or more tires of the vehicle. The means for adjusting may be adapted to use compressed air or pressurized liquid to control the plurality of adjustable supports. The vehicle may, but not necessarily, be a military tactical vehicle.

In yet another embodiment of the present invention, a vehicle may have a system for extending the operating range of a deflated run-flat tire, comprising means for detecting an existing suspension height adjustment of the vehicle, and means for adjusting one or more of a plurality of adjustable supports on the basis of a detected existing suspension height adjustment to compensate for tilting of the vehicle due to the deflated tire.

The means for adjusting may be adapted to adjust one or more of the plurality of adjustable supports by a distance substantially equal to a difference in radius between an inflated run-flat tire and a deflated run-flat tire.

The vehicle may include a pair of parallel wheels having separate wheels located on opposite sides of the vehicle and mounted on respective suspension components attached to a vehicle chassis, wherein the plurality of adjustable supports may include a separate adjustable support located to determine a suspension height adjustment between each respective wheel and the chassis.

The vehicle may include a second pair of parallel wheels having separate wheels located on opposite sides of the vehicle and mounted on respective suspension components attached to a vehicle chassis, said second pair of parallel wheels being longitudinally separated along the vehicle chassis from the first recited pair of parallel wheels, further wherein the plurality of adjustable supports may include a separate adjustable support located to determine a suspension height adjustment between the chassis and each respective wheel of the second pair of parallel wheels. The means for adjusting may be adapted to compensate for tilting in a longitudinal direction of the vehicle.

For a better understanding of the present invention, together with other and further objects thereof, reference is made to the accompanying drawings and detailed description and its scope will be pointed out in the appended claims.

### BRIEF DESCRIPTION OF THE DRAWINGS

FIG. 1 is a schematic illustration of a vehicle according to an embodiment of the present invention having adjustable supports and run-flat tires;

FIG. 2 is a cross-sectional schematic illustration of a portion of a run-flat tire;

FIG. 3 is a schematic illustration of an embodiment according to the present invention showing a system for adjusting or compensating for the tilt associated with a vehicle having a deflated run-flat tire;

FIG. 4 is a schematic illustration of a vehicle according to an embodiment of the invention having a deflated run-flat tire;

FIG. 5 is a flow chart of a method according to an embodiment of the present invention for identifying deflated run-flat tires and for adjusting adjustable supports;

FIG. 6 is a flow chart of a method for adjusting adjustable supports;

FIG. 7A is a schematic illustration of a vehicle operating on a deflated run-flat tire with an off-road suspension height;

FIG. 7B is a schematic illustration of a vehicle according to an embodiment of the present invention operating on a deflated run-flat tire with an off-road suspension height after adjustment of at least one adjustable support;

FIG. 8A is a schematic illustration of a front view of a vehicle operating on a deflated run-flat tire with an on-road suspension height;

FIG. 8B is a schematic illustration of a front view of a vehicle according to another embodiment of the present invention operating on a deflated run-flat tire with an on-road suspension height after adjustment of at least one adjustable support; and

FIG. 9 is a perspective view of a sample independent suspension unit capable of use with various embodiments of the present invention.

### DETAILED DESCRIPTION OF THE INVENTION

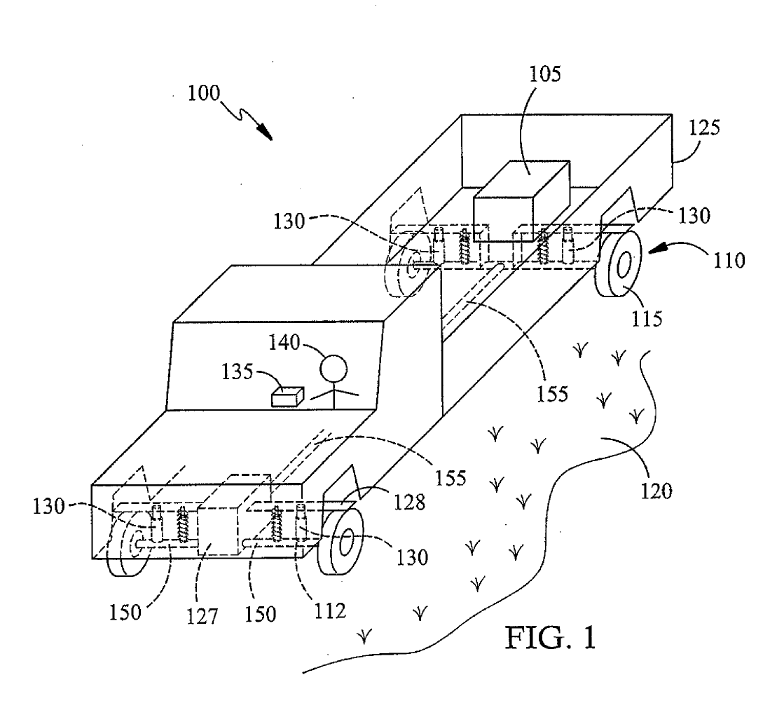

FIG. 1 illustrates a vehicle according to an embodiment of the present invention. The vehicle 100 is capable of carrying a load 105. Each wheel 110 of vehicle 100 contacts the ground or terrain 120 with a tire 115 and is supported by an independent suspension 112. Each tire 115 (shown in its inflated condition in FIG. 1) is typically a run-flat tire. The body, chassis or sprung portion 125 of the vehicle 100 is suspended above each wheel 110 by an adjustable support 130, illustrated in schematic fashion in FIG. 1 to work in parallel with the independent suspension 112 and which may include an air spring or a hydraulic strut. The adjustable support 130 provides a variable suspension height for the vehicle body or chassis 125. Controls 135 for the selective expansion of the adjustable supports 130 may be in the vehicle 100 and operated manually by the operator 140 of the vehicle 100.

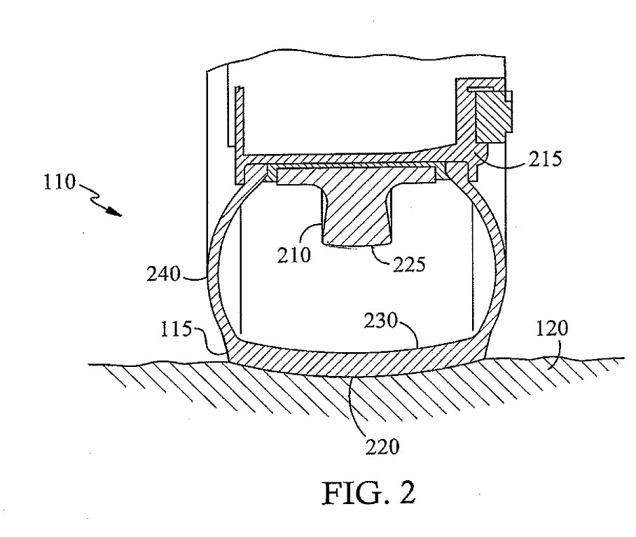

FIG. 2 contains a cross-sectional view of a portion of a wheel 110, including a run-flat tire 115 with a run-flat insert 210. In FIG. 2, the run-flat insert 210 is fixed to a rim 215 of the wheel 110 and projects approximately half way between the rim 215 and the tire tread 220. In other embodiments of the present invention, the run-flat insert 210 may be integral with the run-flat tire 115. When the run-flat tire 115 is inflated, pressurized air within the tire 115 suspends the wheel rim 215 above the tread 220. Should the run-flat tire 115 lose air pressure and deflate, the rim 215 falls toward the ground 120 until the outer surface 225 of the run-flat insert 210 rests against the back 230 of the tread 220. In such a situation, the run-flat insert 210 supports the weight of the vehicle 100 carried by that wheel 110. Although a deflated run-flat tire incorporating the run-flat tire insert 210 may continue to support the vehicle 100 in rolling mode, the run-flat insert 210 does not offer a permanent solution.

The vehicle 100 may run on the run-flat insert 210 for only a limited distance without damaging or destroying the tire 115 (FIG. 1) or the run-flat insert 210. Ordinarily, the sprung body or chassis 125 of the vehicle 100 is level with, that is, parallel to the terrain or ground 120 over which the vehicle 100 moves. However, when the vehicle 100 runs or operates on the run-flat insert 210, additional weight is transferred from the inflated run-flat tires unto the deflated run-flat tire. The additional weight on the deflated run-flat tire imposes a further load that may accelerate damage to the deflated run-flat tire and to the run-flat insert 210. The present invention can delay damage incurred by a deflated run-flat tire and the run-flat insert 210 and therewith extend the range of travel of the vehicle 100 running on the deflated run-flat tire and the run-flat insert 210.

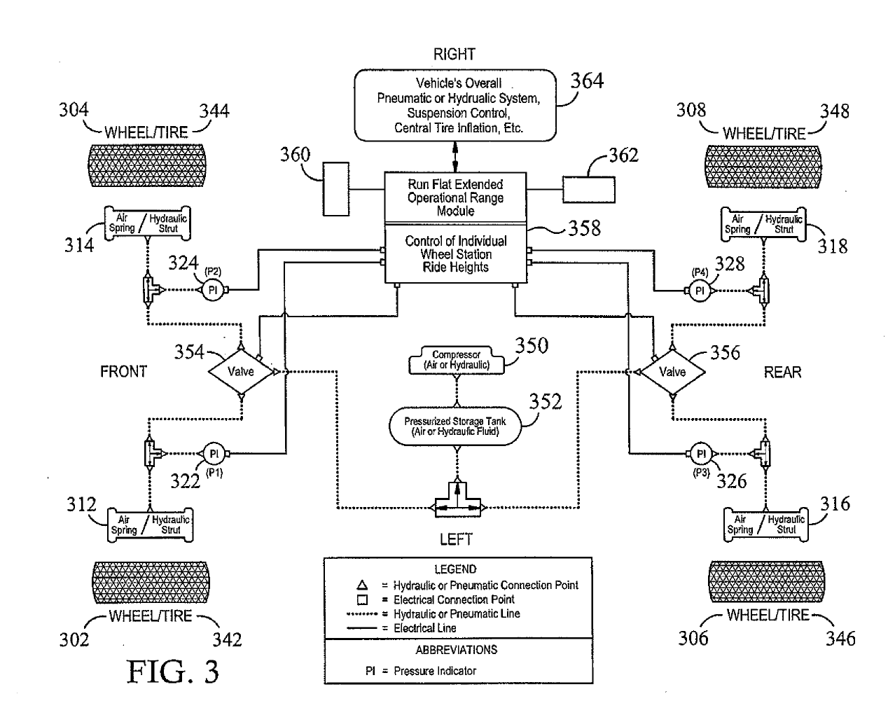

FIG. 3 contains a schematic illustration of the components of an embodiment according to the present invention. Each wheel 110 enumerated in FIG. 3 as, front left 302, front right 304, rear left 306, and rear right 308 is provided with an adjustable support 130 (FIG. 1) in the form of an air spring or a hydraulic strut for front left 312, front right 314, rear left 316, and rear right 318 collectively supporting the sprung portion 125 (FIG. 1) over each wheel 110.

The pressurizing device 350 may be a compressor supplying a compressed gas such as compressed air, or it may be a pump supplying a pressurized liquid such as pressurized hydraulic fluid, to a storage tank 352 for use in expanding the adjustable supports 312, 314, 316, 318. Pressure indicators 322, 324, 326 and 328 are interposed, respectively, between adjustable supports 312, 314, 316, 318 and controller 358. The storage tank 352 is connected with a front valve 354 and with a rear valve 356. The front valve 354 selectively provides pressurized fluid to the front left and right air spring/hydraulic struts 312, 314, and the rear valve selectively provides pressurized fluid to the rear left and right air spring/hydraulic struts 316, 318.

A controller 358 furnishes signals to the front valve 354 and to the rear valve 356, allowing selective expansion or contraction of the front left 312, front right 314, rear left 316, and rear right 318 air spring/hydraulic strut. Where the adjustable supports 130 are air springs, for example, expansion corresponds to inflation of the air springs and contraction corresponds to deflation of the air springs. The adjustable supports 130 may also be any suitable driveable mechanisms. Lateral and longitudinal tilt sensors 360, 362, respectively, may be linked to either controller 358 or an overall suspension control system 364.

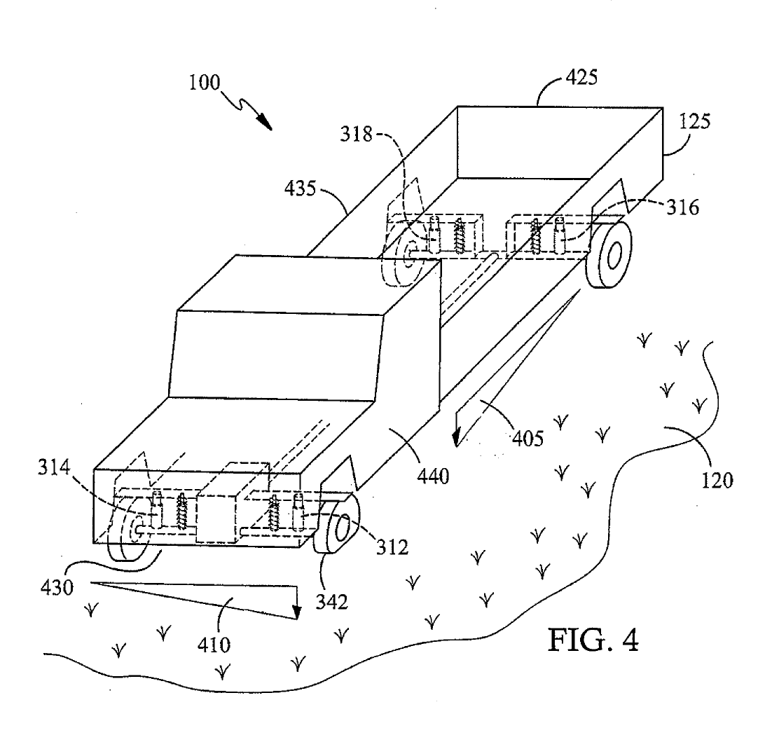

As diagrammed in FIG. 4, operator assessment or a signal from a central tire inflation system (CTIS) may indicate the presence of a deflated tire 342. In some circumstances, the tilt of the vehicle 100, that is, the angle that the sprung portion 125 makes with the terrain 120 or unsprung portion 127 in the longitudinal or rear-to-front direction and in the lateral or right-to-left direction as observed or even automatically sensed, may also indicate the possibility of a deflated or under inflated tire. Longitudinal tilt 405 refers to tilt from back to front and lateral tilt refers to tilt from right to left. A tilt where the rear 425 of the vehicle 100 is lower than the front 430 of the vehicle 100 relative to the ground or terrain 120 is positive and a tilt where the rear 425 of the vehicle 100 is higher than the front 430 of the vehicle 100 relative to the ground or terrain 120 is negative. A tilt where the right side 435 of the vehicle 100 is lower than the left side 440 relative to the ground or terrain 120 is positive and a tilt where the right side 435 of the vehicle 100 is higher than the left side 440 relative to the ground or terrain 120 is negative. Right and left reflect the orientation of the operator 140 (FIG. 1) of the vehicle 100 facing forward. FIG. 4 illustrates a vehicle 100 with a negative longitudinal tilt 405 and a negative lateral tilt 410 as a result of deflated front left run-flat tire 342.

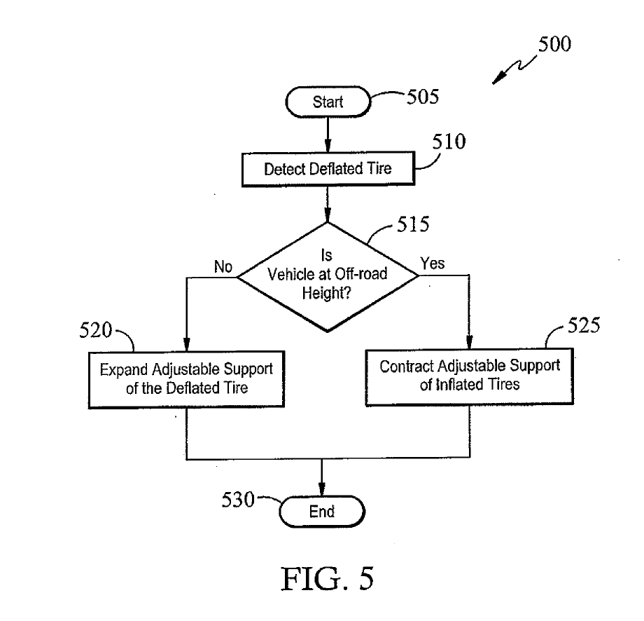

FIG. 5 contains a flow chart of a method 500 according to an embodiment of the invention for compensating for vehicle tilt caused by a deflated or under inflated tire 342 (FIG. 4). In step 510, a deflated tire 342 is detected. Detection may be the result of observation by the operator 140 (FIG. 1) or a CTIS error message. In step 515, there is, under certain circumstances, determination of a suspension height adjustment, or off-road status of the vehicle 100, whether the vehicle 100 (FIG. 1) is adjusted for off-road operation where the sprung body or chassis 125 is at an extended suspension height. The current suspension height is used to determine the proper compensation of the deflated tire. If the sprung body or chassis 125 is not adjusted to the extended height, the adjustable support 312 of the deflated tire 342 is expanded (step 520). If the sprung body or chassis 125 is adjusted to the extended suspension height, the adjustable supports of the inflated tires are contracted (step 525).

To determine whether the tilt of the vehicle 100 has been eliminated and the vehicle 100 is level with the terrain 120, adjustment of the adjustable supports 312, 314 continues until the tilt of the sprung body or chassis 125 substantially matches the tilt of the terrain 120. An operator 140 may observe the tilt of the vehicle 100, either with or without reference to tilt sensors 360, 362, and discontinue adjustment of the adjustable supports 312, 314 when the sprung body or chassis 125 is level with the ground 120.

Still another approach is to use the difference in rolling radius between an inflated run-flat tire 115 and a deflated run-flat tire 342 as provided by the manufacturer of the run-flat tire to determine the adjustment to the appropriate adjustable supports 312, 314, 316, 318 necessary to level the vehicle 100 with the terrain 120.

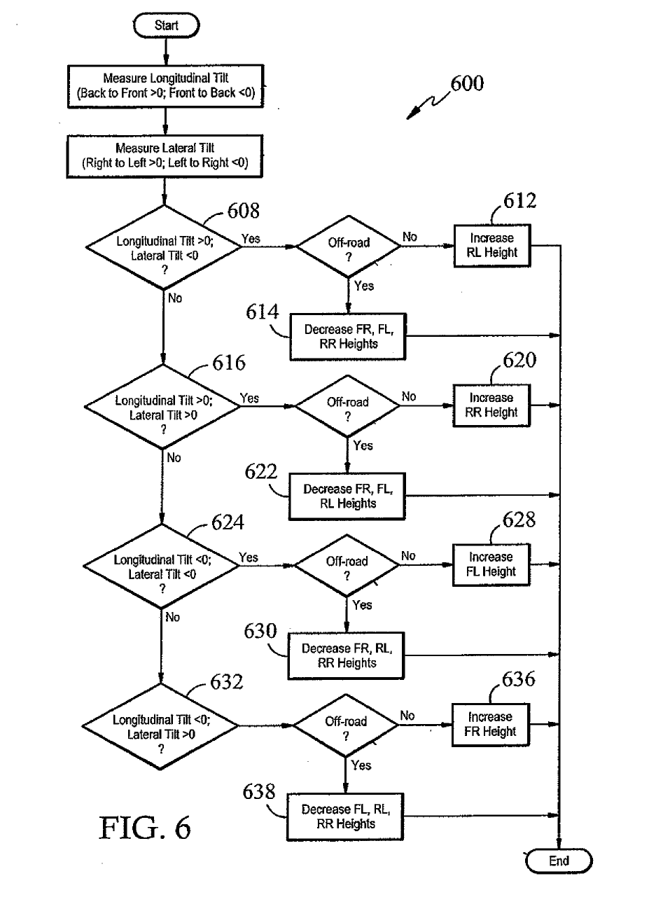

FIG. 6 contains a flow chart of an example of a method 600, where the deflated run-flat tire is detected by the operator 140 (FIG. 1) or by the CTIS. Once the identity of the deflated run-flat tire resting on its run-flat insert 210 (FIG. 2) has been determined either by lateral or longitudinal tilt or other type of sensing such as by a decrease in tire air pressure or other operator assessment, the orientation of an appropriate corner of the sprung body or chassis 125 may be adjusted.

In order to provide an illustrative example of, for instance, where run-flat tire 342 (used as an example) is deflated, reference is now made, but not limited to, FIGS. 4, 6, 7A, 7B, 8A and 8B. Therefore, in the flow chart shown in FIG. 6, decision boxes 608 and 616 provide a direct flow through to decision box 624, which is the decision box used with the example of deflated run-flat tire 342. If the longitudinal tilt 405 is less than zero, that is, if the front 430 of vehicle 100 is lower than the rear 425 of vehicle 100, and if the lateral tilt 410 is less than zero (see 624), that is, if the left side 440 of the vehicle 100 is lower than the right side 435 of the vehicle 100, then, for example, the front left run-flat tire 342 has been deflated. If the vehicle suspension is in on-road condition, that is, if the suspension has not been elevated and still corresponds to the on-road level, then, to even the level of the sprung body or chassis 125, the specific adjustable support 312 over the front deflated left run-flat tire 342 is extended (see 628). If the vehicle suspension is in an off-road condition where the suspension has been expanded to raise the sprung body or chassis 125, then, the front right 314, rear right 318, and rear left 316 adjustable supports are contracted (see 630) to bring the sprung body or chassis 125 to a position even or level with the ground 120.

It is not necessary to provide separately for both off-road and on-road conditions, since the present invention operates properly without such special arrangements. However, if desired, such a feature may be provided as discussed below.

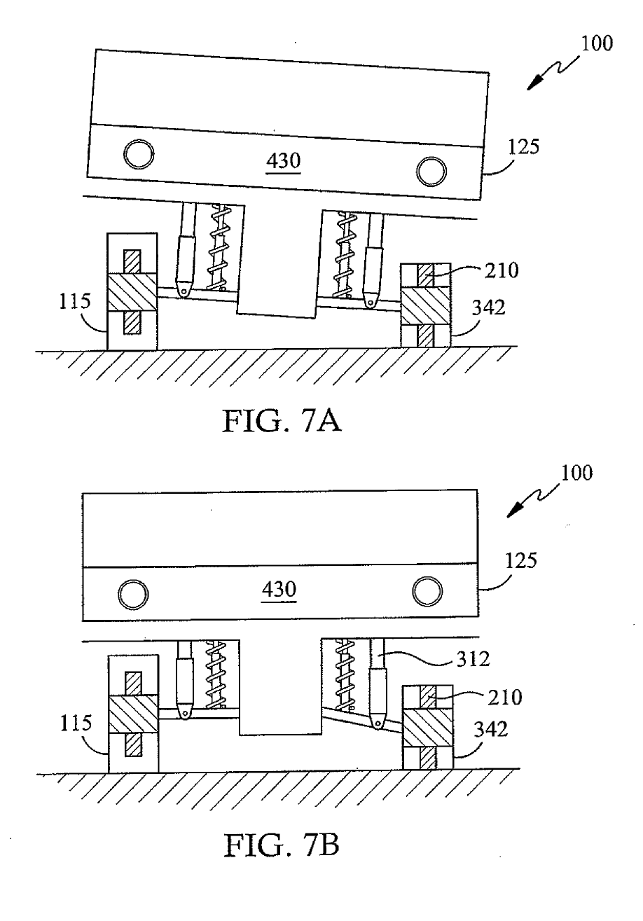

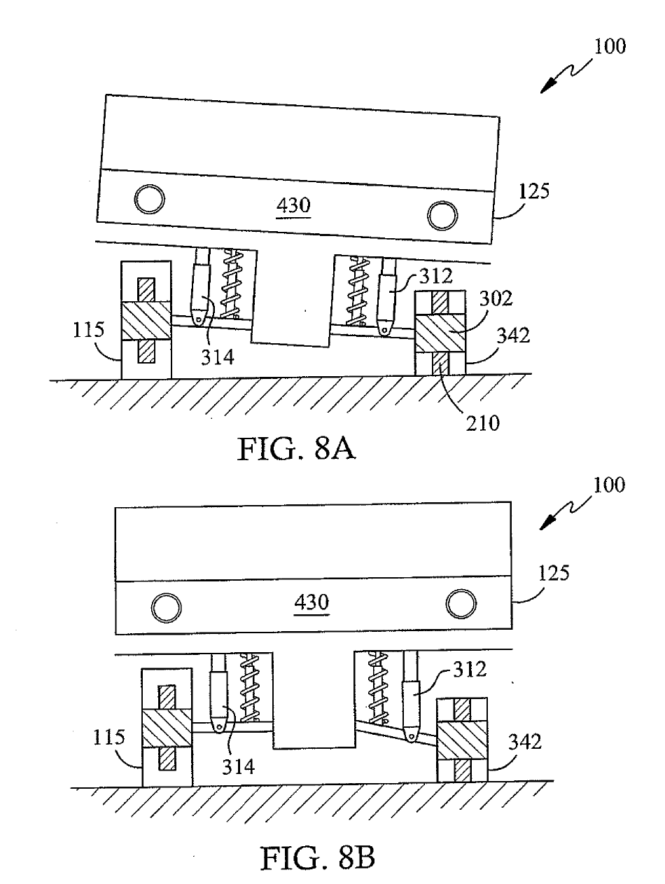

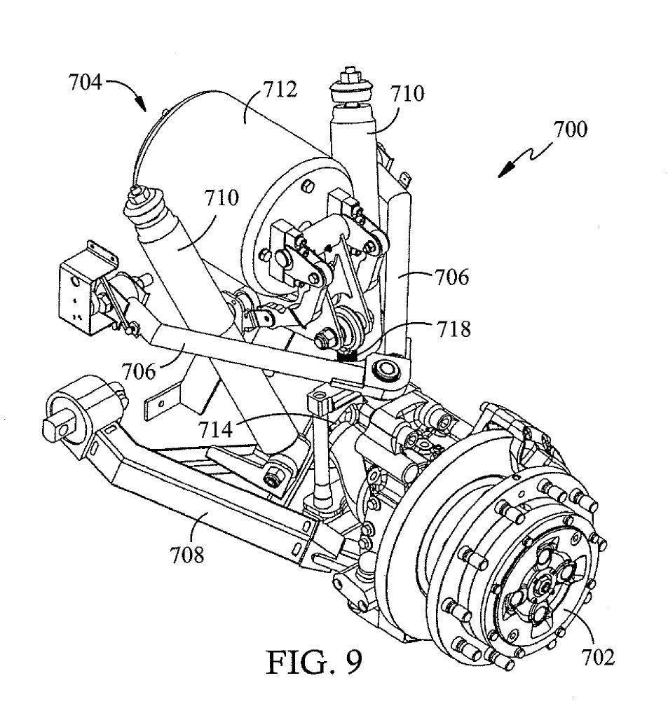

An example of an embodiment of the present invention where the front left run-flat tire 342 is deflated is illustrated in FIG. 7A and FIG. 7B for an off-road condition and in FIG. 8A and FIG. 8B for an on-road condition. The suspension components are very generally represented in FIGS. 7A, 7B, 8A, 8B for purposes illustrating the functionality of adjusting the suspension for a deflated tire. Details of suspension components are described in respect to FIG. 9 and described in more detail below. In FIGS. 7A and 7B, the vehicle 100 is shown in the off-road condition, where the front left run-flat tire 342 is deflated and is running on insert 210 and where the vehicle 100 has assumed a tilt toward the front left run-flat tire 342. Since the vehicle suspension is raised for off-road travel, the adjustable supports, including the front left 312, have substantially no additional capacity for extension. Since the vehicle suspension is adjusted for off-road, the level of the sprung body or chassis 125 is evened with the terrain, as shown in FIG. 7B, by having the adjustable supports 314 for the inflated front right tire 344 (FIG. 3), as well as supports 316, 318 for the rear left tire 346, and rear right tire 348, respectively (FIG. 3) contracted as shown in FIG. 7B.

FIGS. 8A and 8B illustrate the vehicle 100 adjusted for on-road operation and the adjustable supports are contracted. As in FIG. 7A and FIG. 7B, in FIGS. 8A and 8B the front left run-flat tire 342 is deflated and is supported on its run-flat insert 210. To make the sprung portion 125 even with the terrain, the adjustable support 312 for the deflated front left run-flat tire 342 is extended appropriately while the other adjustable supports remain substantially in the contracted positions as shown in FIG. 8B.

Referring back to FIGS. 3, 4 and 6, in the event, for example, that the rear right run-flat tire 348 is deflated, the longitudinal tilt 405 is greater than zero and the lateral tilt 410 is greater than zero (see 616), that is, the rear 425 is lower than the front 430 and the right side 435 is lower that the left side 440. If the vehicle 100 is adjusted for on-road operation, leveling of the sprung body or chassis 125 is accomplished by extending the rear right adjustable support 318 (see 620). If the vehicle suspension is adjusted for off-road operation, evening the level of the sprung body or chassis 125 involves decreasing the heights of the front right 312, front left 314, and rear left 316 adjustable supports associated with the front right 304, front left 302, and rear left 306 wheels (see 622).

If, for example, the longitudinal tilt 405 is less than zero, that is, if the front 430 is lower than the rear 425, and the lateral tilt 410 is greater than zero (see 632), that is, if the right 435 is lower than the left 440, then the front right run-flat tire 344 is deflated. If the vehicle suspension is adjusted for on-road operation, leveling of the sprung body or chassis 125 involves extending the front right adjustable support 314 (see 636). If the vehicle suspension is adjusted for off-road operation, then leveling the sprung body or chassis 125 involves contracting the front left 312, rear left 316, and rear right 318 adjustable supports (see 638).

If, for example, the longitudinal tilt 405 is greater than zero, that is, if the rear 425 is lower than the front 430, and if the lateral tilt 410 is less than zero (see 608), that is, if the left side 440 is lower than the right side 435, the rear left run-flat tire 346 is deflated. Leveling of the sprung body or chassis 125 involves extending the rear left adjustable support 316 (see 612) for a vehicle suspension adjusted for on-road operation. If the vehicle suspension is adjusted for off-road operation, then leveling involves contracting the front left 312, front right 314, and rear right 318 adjustable supports (see 614).

The following examples set forth other run-flat tire deflated conditions and are described without the use of additional flow charts but with reference to, but not limited to, FIGS. 3 and 4. For example, deflation of two adjacent run-flat tires is identifiable by an absence of either longitudinal tilt 405 or lateral tilt 410, but not both. If the longitudinal tilt 405 is greater than zero, and the lateral tilt 410 is substantially equal to zero, then the rear left 346 and the rear right 348 run-flat tires are deflated. If the vehicle suspension is adjusted for on-road operation, extension of the rear left 316 and the rear right 318 adjustable supports levels the sprung portion 125 with the ground 120 or the unsprung portion 127. If the vehicle suspension is adjusted for off-road operation, leveling of the sprung portion 125 is accomplished by contracting the front right 314 and front left 312 adjustable supports.

If, for example, the longitudinal tilt 405 is less than zero, that is, if the front 430 is lower than the rear 425, and if the lateral tilt is substantially zero, the front left 342 and front right 344 run-flat tires are deflated. If the vehicle suspension is adjusted for on-road operation, the sprung body or chassis 125 is restored to be level with the ground 120 by extension of the front left 312 and front right 314 adjustable supports. If the vehicle suspension is adjusted for off-road operation, the sprung body or chassis 125 is made level with the ground 120 by contraction of the rear right 318 and rear left 316 adjustable supports.

If, for example, the longitudinal tilt 405 is substantially zero and the lateral tilt is greater than zero, that is, if the left side 440 is higher than the right side 435, then the rear right 348 and front right 344 run-flat tires are deflated. If the vehicle suspension is adjusted for on-road operation, the sprung body or chassis 125 is made level with the ground 120 by extension of the front right 314 and rear right 318 adjustable supports. If the vehicle suspension is adjusted for off-road operation, the sprung body or chassis 125 is made level with the ground 120 by contraction of the rear left 316 and front left 312 adjustable supports.

In addition, it should be realized that the present invention is also applicable, for example, in situations where three run flat tires are deflated or even where two run-flat tires diagonally opposed from each other are deflated. Upon identification of such conditions, leveling of the spring body or chassis 125 is accomplished in the following manner. In the on-road operation, the sprung body or chassis 125 is restored to level with the ground 120 by extension of the adjustable supports associated with the deflated run flat tires. In the off-road operation, the sprung body or chassis 125 is restored to level with the ground 120 by contraction of the adjustable support associated with the inflated run-flat tires.

If the longitudinal tilt 405 is substantially zero and the lateral tilt is less than zero, that is, if the left side 440 is lower than the right side 435, then the rear left 346 and front left 342 run-flat tires are deflated. If the vehicle suspension is adjusted for on-road operation, the sprung body or chassis 125 is made level with the ground 120 by extension of the rear left 316 and front left 312 adjustable supports. If the vehicle suspension is adjusted for off-road operation, the sprung body or chassis 125 is made level with the ground 120 by contraction of the rear right 318 and front right 314 adjustable supports.

FIG. 9 shows a perspective view of a sample independent suspension unit 700 suitable for use with the various embodiments of the present invention. Generally included are a wheel hub 702, an upper suspension arm 706, a lower suspension arm 708, a pair of shock absorbers 710 and an adjustable compressed air bag type of device, such as an air spring 712. Upper and lower suspension arms 706, 708, respectively, are adapted to maintain a vertical orientation for wheel hub 702 and a wheel mounted thereon while the wheel hub is allowed to move up and down in response to various conditions. Shock absorbers 710 provide support to lower suspension arm 708 from chassis connection points (not shown) to provide dampening of suspension movement. Air spring 712 is adapted for connection to the chassis at one end 704. Air spring 712 is also adapted for connection to lower suspension arm 708 through a connecting member 718. In this manner, inflation of air spring 712 causes the lowering of wheel hub 702 with respect to the chassis to thereby provide a higher suspension height for a vehicle.

Although the invention has been described with respect to various embodiments, it should be realized that this invention is also capable of a wide variety of further and other embodiments within the spirit and the scope of the appended claims. For example, use of this system may be applicable to any vehicle having a real time independent adjustable suspension system and not limited to vehicles with on-road/off-road capability.

What is claimed is:

1. A method for extending the operating range of a deflated run-flat tire on a vehicle having a plurality of adjustable wheel supports, comprising the steps of:
determining that a run-flat tire on the vehicle is deflated; and
adjusting at least one of a plurality of adjustable wheel supports to change the vehicle attitude to prevent additional weight and side loads from being placed on at least one deflated run-flat tire.

2. The method of claim 1, wherein the step of adjusting includes adjusting one or more of the plurality of adjustable wheel supports by a distance substantially equal to a difference in rolling radius between an inflated run-flat tire and a deflated run-flat tire.

3. The method of claim 1, wherein the vehicle includes a pair of parallel wheels with separate run-flat tires having separate wheels located opposite each other on opposite sides of the vehicle and mounted on respective suspension components attached to a chassis of the vehicle, the plurality of adjustable wheel supports includes a separate adjustable height support located to provide a suspension height adjustment between each respective wheel and the chassis, and the step of adjusting includes adjusting at least one of the plurality of adjustable wheel supports to compensate for tilting of the vehicle caused by the at least one deflated run-flat tire.

4. The method of claim 3, wherein the step of adjusting includes contracting at least one adjustable wheel support corresponding to a run-flat tire that is still inflated to compensate for tilting of the vehicle caused by the at least one deflated run-flat tire.

5. The method of claim 4, wherein the step of determining that a run-flat tire is deflated includes monitoring air pressure in at least one run-flat tire of the vehicle.

6. The method of claim 5, wherein the step of adjusting includes monitoring vehicle tilt.

7. The method of claim 3, wherein the step of adjusting includes extending an adjustable wheel support corresponding to a run-flat tire that is deflated to compensate for tilting of the vehicle caused by the at least one deflated run-flat tire.

8. The method of claim 7, wherein the step of determining that a tire is deflated includes monitoring air pressure in the at least one run-flat tire of the vehicle.

9. The method of claim 8, wherein the step of adjusting includes monitoring vehicle tilt.

10. A system for extending the operating range of a deflated run-flat tire on a vehicle having a plurality of adjustable wheel supports, the system comprising:
means for detecting at least one deflated run-flat tire on the vehicle; and
means for adjusting at least one of a plurality of adjustable wheel supports to change the vehicle attitude to prevent additional weight and side loads from being placed on the at least one deflated run-flat tire.

11. The system of claim 10, wherein the means for adjusting is adapted to adjust at least one of the plurality of adjustable wheel supports by a distance substantially equal to a difference in rolling radius between an inflated run-flat tire and a deflated run-flat tire.

12. The system of claim 11, wherein the vehicle includes a pair of parallel wheels having separate wheels located opposite each other on opposite sides of the vehicle and mounted on respective suspension components attached to a vehicle chassis, the plurality of adjustable wheel supports including a separate adjustable height support located to provide a suspension height adjustment between each respective wheel and the chassis.

13. The system of claim 12 wherein the vehicle includes a second pair of parallel wheels having separate wheels located opposite each other on opposite sides of the vehicle and mounted on respective suspension components attached to the chassis, said second pair of parallel wheels being longitudinally separated along the vehicle chassis from the first recited pair of parallel wheels; and
the plurality of adjustable tire supports including a separate adjustable support located to provide a suspension height adjustment between the chassis and each respective wheel of the second pair of parallel wheels.

14. The system of claim 13, wherein the means for adjusting is adapted to compensate for tilting in a longitudinal and/or lateral direction of the vehicle.

15. The system of claim 13, wherein the means for adjusting is adapted to use compressed air or pressurized liquid to control the plurality of adjustable tire supports.

16. The system of claim 13, wherein the vehicle is a military tactical vehicle.

17. In a system for extending the operating range of a deflated run-flat tire on a military tactical vehicle having a plurality of adjustable wheel supports, the improvement comprising:
means for detecting at least one deflated run-flat tire on the vehicle; and
means for adjusting at least one of a plurality of adjustable wheel supports to change the vehicle attitude to prevent additional weight and side loads from being placed on the at least one deflated run-flat tire.

18. The system of claim 17, wherein the means for adjusting is adapted to adjust at least one of the plurality of adjustable wheel supports by a distance substantially equal to a difference in rolling radius between an inflated run-flat tire and a deflated run-flat tire.

19. The system of claim 17, wherein the vehicle includes a pair of parallel wheels having separate wheels located on opposite sides of the vehicle and mounted on respective suspension components attached to a vehicle chassis, and the plurality of adjustable wheel supports includes a separate adjustable height support located to provide a suspension height adjustment between each respective wheel and the chassis.

20. The system of claim 17, wherein the vehicle includes a second pair of parallel wheels having separate wheels located on opposite sides of the vehicle and mounted on respective suspension components attached to a vehicle chassis, said second pair of parallel wheels being longitudinally separated along the vehicle chassis from the first recited pair of parallel wheels; and
the plurality of adjustable wheel supports include a separate adjustable height support located to provide a suspension height adjustment between the chassis and each respective wheel of the second pair of parallel wheels.

21. The system of claim 20, wherein the means for adjusting is adapted to compensate for tilting in a longitudinal and/or lateral direction of the vehicle.

22. The method of claim 1 wherein the step of adjusting includes contracting at least one of the wheel supports corresponding to a run-flat tire that is still inflated to compensate for tilting of the vehicle caused by the at least one deflated run-flat tire.

23. The method of claim 1 wherein the step of adjusting includes extending an adjustable wheel support corresponding to a run-flat tire that is deflated to compensate for tilting of the vehicle caused by the at least one deflated run-flat tire.
